(19) United States
(12) Patent Application Publication
(10) Pub. No.: US 2020/0315154 A1
(43) Pub. Date: Oct. 8, 2020

(54) SPRAYING DEVICE

(71) Applicant: EXEL INDUSTRIES, PARIS (FR)

(72) Inventor: Josep GODIA, PARIS (FR)

(21) Appl. No.: 16/767,080

(22) PCT Filed: Nov. 27, 2018
(86) PCT No.: PCT/FR2018/053008

§ 371 Date: May 26, 2020

(30) Foreign Application Priority Data
Nov. 27, 2017 (FR) 17/61228

(51) Int. Cl. A01M 7/00

(52) U.S. Cl. CPC A01M 7/0014; A01M 7/0042; A01M 7/0089; A01M 7/006

(57) ABSTRACT

Spraying device for an agricultural machine, comprising a carrier and at least one nozzle capable of spraying an aerosol product, the carrier being hollow in order to be able to conduct propellant air to the at least one nozzle, the at least one nozzle being selectively mountable on and dismountable from the carrier, preferably without using tools.

The present invention relates to an agricultural machine spraying device. A spraying device is conventionally used, carried by agricultural machine, such as a tractor or a trailer, to cross a crop plantation, advantageously in rows, such as trees or vines, and help spray a phytosanitary product on said crops.

After use, it is preferable to clean the spraying device, typically with a pressurised water jet, inside and outside, in order to remove the phytosanitary product. Existing spraying devices are generally not easy to clean, particularly the inside which is difficult to access.

Moreover, existing devices are not very suitable for dismantling or only with difficulty. They further have high production and maintenance costs due to not very optimised designs. A significant disturbance of the air flow can generally be observed at the junction of a nozzle and induces a loss of power for the more downstream nozzles. Existing devices are designed to work at a single distance from vegetation.

The present invention remedies these various drawbacks by proposing a device wherein the nozzles are readily mountable and dismountable in respect of the carrier thereof.

The invention relates to a spraying device for agricultural machine, comprising a carrier and at least one nozzle suitable for spraying an aerosol product, the carrier being hollow so as to be suitable for transporting a propellant air to said at least one nozzle, where said at least one nozzle is selectively mountable and dismountable in respect of the carrier, preferentially without tools.

According to a further feature, the carrier comprises at least one hole cut out in the wall thereof and a nozzle comprises a sleeve suitable for being engaged in a hole, a flange surrounding the sleeve and suitable for covering the outer periphery of the hole, and at least two tappets protruding radially from the sleeve so as to be able to hook the inner periphery of the hole, preferentially opposite in relation to the hole.

According to a further feature, one of said at least two tappets is fixed and the other of said at least two tappets is movable between a hooked position where it can hook the inner periphery of the hole and a retracted position, the change of position being capable of being made by means of a lever comprising a control preferentially disposed on the outside.

According to a further feature, the sleeve comprises a scoop facing the propellant air supply and forms a bend between the scoop and the flange.

According to a further feature, the carrier comprises an increase in cross-section around a hole.

According to a further feature, the nozzle further comprises a housing, disposed extending from the sleeve and hinged in relation to the sleeve, preferentially along a horizontal axis.

According to a further feature, the housing further comprises at least one hinged flap so as to vary the opening of the housing, each flap being preferentially independently adjustable, and the hinge axis thereof being further preferentially horizontal.

According to a further feature, the housing comprises two flaps, preferentially symmetrical.

According to a further feature, the nozzle further comprises an adjustable sealing means.

According to a further feature, the sealing means comprises a rotary valve disposed in the housing, preferentially cylindrical and more preferentially of vertical axis.

According to a further feature, the nozzle further comprises a means for fastening a discharger in the opening of the housing and/or a means for fastening a sprinkler next to the opening of the housing.

The invention further relates to such a nozzle.

In other words, the invention also relates to a nozzle suitable for spraying an aerosol product for a spraying device for agricultural machine of the type comprising a hollow carrier so as to be suitable for transporting a propellant air to said nozzle and the carrier comprising at least one hole cut out in the wall thereof, the nozzle being characterised in that it is configured to be selectively mountable and dismountable in respect of the carrier, preferentially without tools, and in that it comprises a sleeve suitable for being engaged in the hole, a flange surrounding the sleeve and suitable for covering the outer periphery of the hole, and at least two tappets protruding radially from the sleeve so as to be able to hook/engage the inner periphery of the hole, preferentially opposite in relation to the hole.

The term “nozzle” denotes an assembly configured to mix a phytosanitary product with the propellant air to form an aerosol, this assembly being removable in one piece in relation to the carrier.

In order to carry out spraying, an air circuit comprising particularly the hollow carrier supplies propellant air to the nozzle assembly. The propellant air enters via an inlet of the nozzle, traverses same from end to end and emerges via an opening at the outlet, in the form of an air jet directed towards the crops to be treated. The nozzle performs a function of shaping the air jet and dispensing same to the crops to be treated. The phytosanitary product is dispersed at the outlet opening of the nozzle so as to be carried or blown by the air jet into the foliage of the crops to be treated.

The invention further relates to such a carrier.

Further features, details and advantages of the invention will emerge more clearly from the detailed description given hereinafter by way of indication with reference to the drawings wherein:

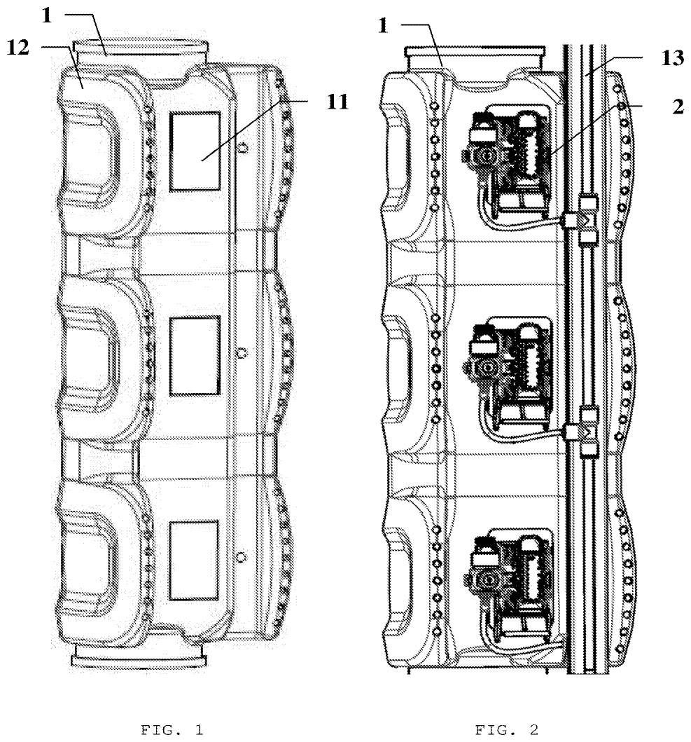

FIG. 1 shows an embodiment of an unequipped carrier,

FIG. 2 shows the carrier in FIG. 1 equipped with three nozzles,

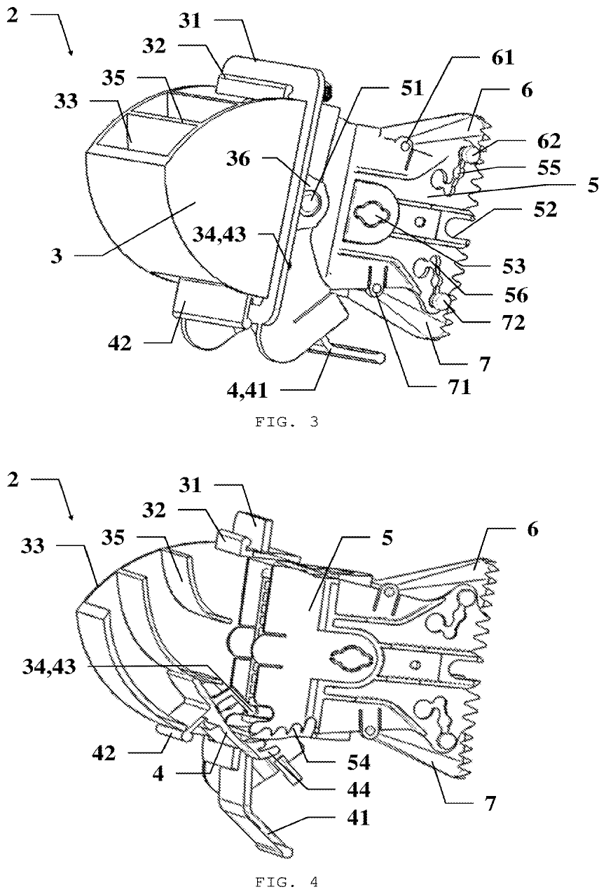

FIG. 3 shows an embodiment of a nozzle, in a rear perspective view, the lever being closed,

FIG. 4 shows the nozzle in FIG. 3 according to the same rear perspective view, herein partially cross-sectioned, the lever being open,

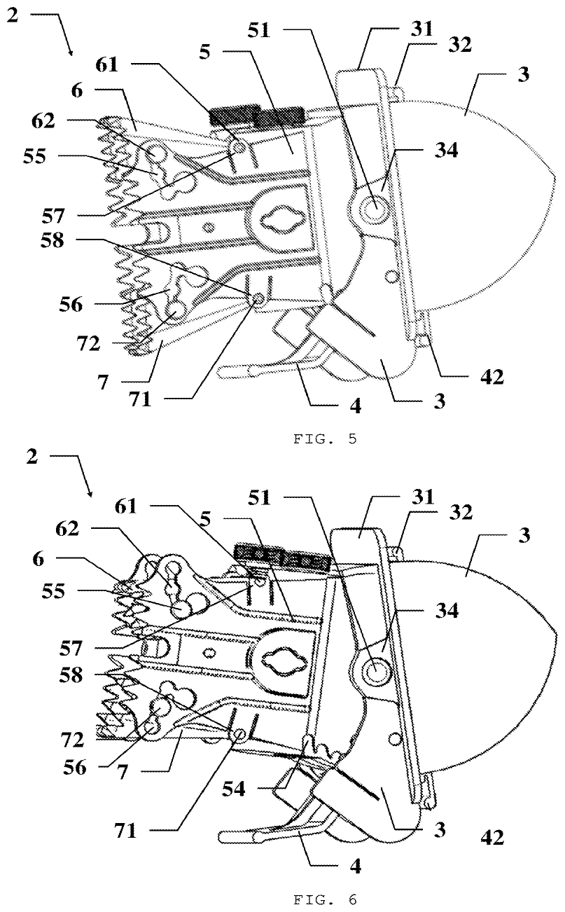

FIGS. 5 and 6 show the nozzle in FIG. 3, in a side perspective view, according to the different settings,

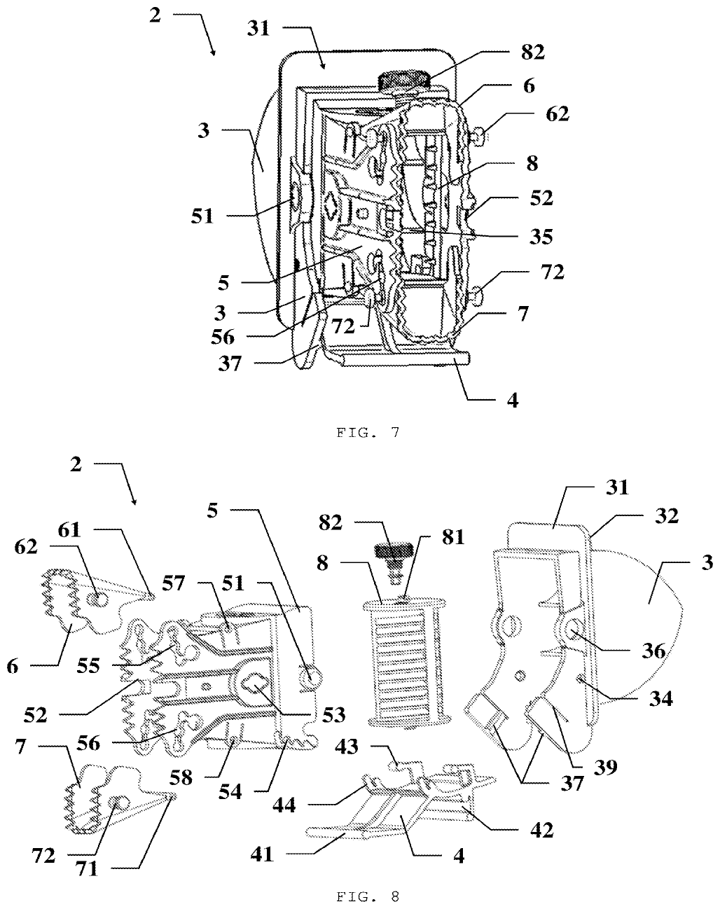

FIG. 7 shows the nozzle in FIG. 3, in a front perspective view,

FIG. 8 shows an exploded view of the nozzle in FIG. 3,

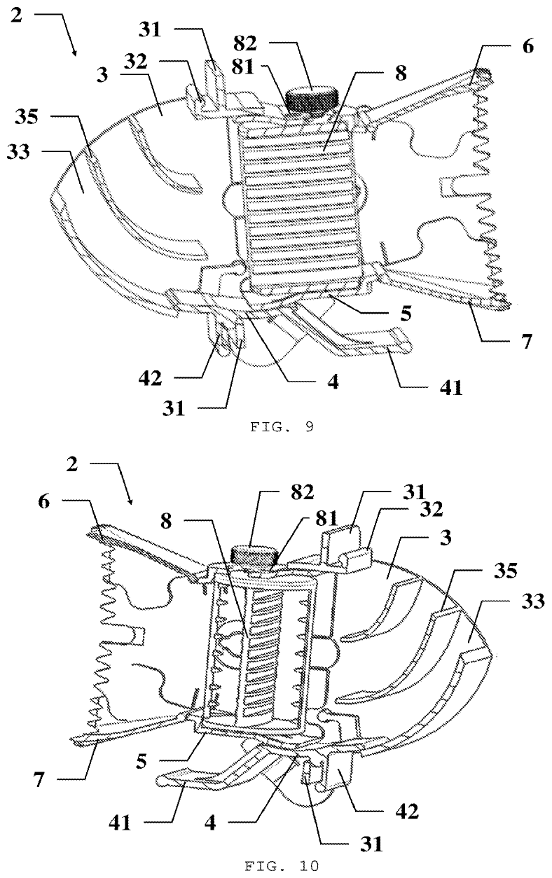

FIG. 9 shows the nozzle in FIG. 3, in a right longitudinal cross-sectional view, the valve being open,

FIG. 10 shows the nozzle in FIG. 3, in a left longitudinal cross-sectional perspective view, the valve being closed,

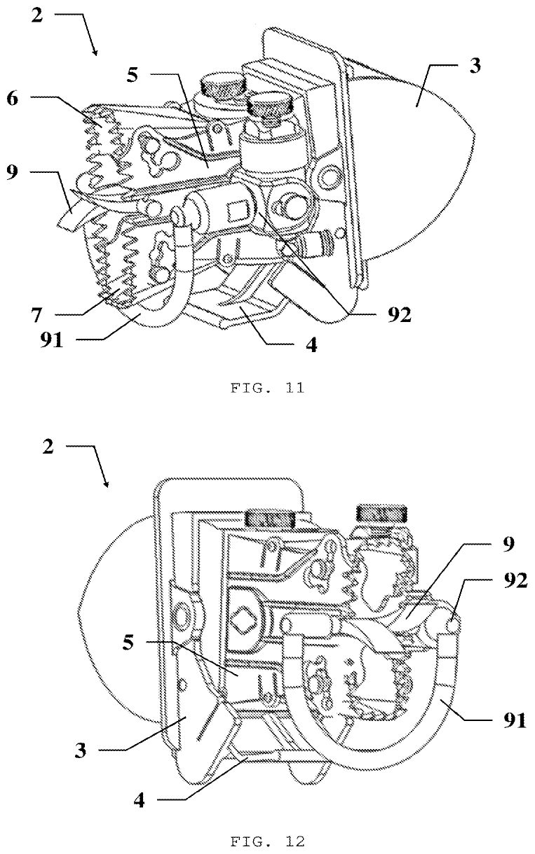

FIGS. 11 and 12 show the nozzle in FIG. 3, in a perspective view according to two viewpoints, equipped with a discharger,

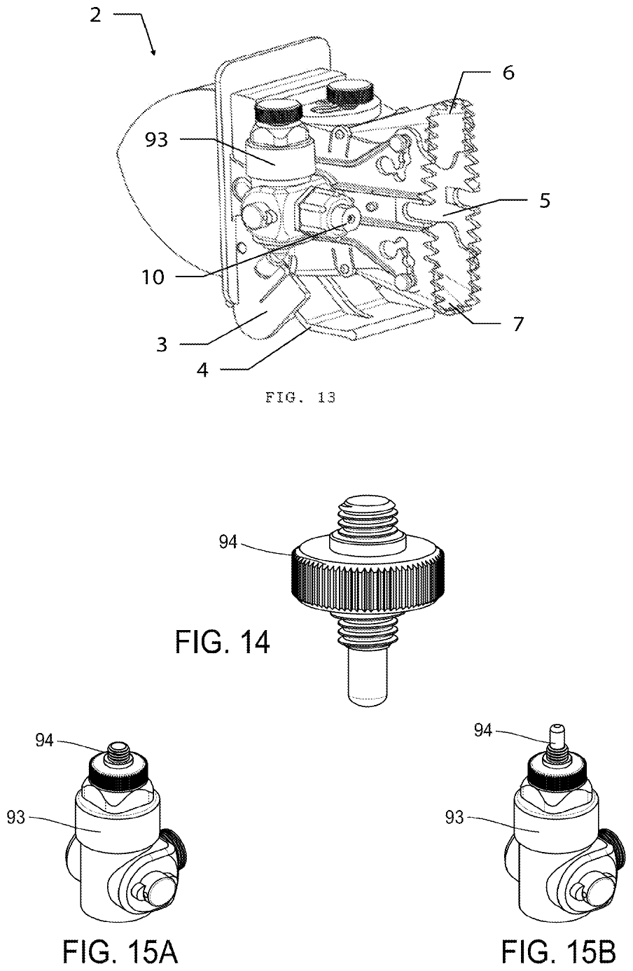

FIG. 13 shows the nozzle in FIG. 3, in a perspective view, equipped with a sprinkler,

FIG. 14 shows a nozzle closing screw for closing, particularly manually, the supply of liquid to be sprayed,

FIGS. 15A and 15B show a support block of a nozzle equipped with a screw as illustrated in FIG. 14.

A spraying device for agricultural machine is movable, in that it is onboard a tractor or a trailer, in order to cross a crop plantation, such as trees or vines, advantageously disposed in rows, and spray a phytosanitary product onto said crops for the treatment thereof. In order to be sprayed, the phytosanitary product, typically liquid, is supplied to a nozzle 2, also known as diffuser, via a first dedicated circuitry 13. In order to carry out spraying effectively, a propellant air is further supplied to the nozzle 2. The propellant air is typically pressurised by an onboard turbine. It is then transported via a second circuitry.

A nozzle 2 is the final link in this second circuitry. The propellant air traverses the nozzle 2 from end to end. The nozzle 2 performs a function of mixing the phytosanitary product with the propellant air to form an aerosol, typically at the outlet of the nozzle 2, and a function of targeted dispensing of the propellant air/aerosol towards the crops to be treated.

The nozzle therefore forms an assembly removable in one piece from the wall bearing same and forming the final link of the first 13 and second circuitry, the nozzle being configured to mix this phytosanitary product with the propellant air to form an aerosol. Such a nozzle or nozzle assembly or nozzle block therefore forms a single assembly integrating the ejection of the propellant air and the delivery of the phytosanitary product to the propellant air. These two final links of the first 13 and second circuitries are therefore combined together to be operated in one piece by the user operating the nozzle 2 integrating same.

A nozzle 2 is mounted on a nozzle carrier 1. A carrier 1, also known as arm, column or downpipe, may take different forms and accommodate one or more nozzles 2. It is most often vertical, descending in that it is suspended under a structure carried by the agricultural machine. The complete spraying device may comprise several such carriers 1.

FIG. 1 illustrates a possible embodiment of a carrier 1 suitable for accommodating three nozzles 2. According to a feature of the invention, the carrier 1, in addition to the function thereof of supporting the nozzle(s) 2, is advantageously hollow. Thus, it forms the penultimate link of the second circuitry and enables the transport of the propellant air to the nozzles 2. According to a possible embodiment, the propellant air arrives via the top of the carrier 1.

FIG. 2 illustrates the carrier 1 in FIG. 1 equipped with three nozzles 2.

According to a feature of the invention, a nozzle 2 is selectively mountable and dismountable in respect of the carrier 1. In order to facilitate work on-site, these mounting and/or dismounting operations are advantageously suitable for being carried out without tools.

For this, the carrier 1 comprises a hole 11 at each station envisaged to accommodate a nozzle 2. This hole 11 is cut in the wall of the carrier 1, advantageously thin or thinned at the level of the hole 11. A hole 11 may be of any shape, for example circular. A non-circular shape, for example rectangular, as illustrated, is advantageous in that it makes it possible to index the nozzle 2 in rotation about the axis thereof. A dissymmetrical shape (not shown) is further advantageous in that it makes it possible to carry out fool-proofing requiring a single orientation of the nozzle 2 without the possibility of mounting error.

As illustrated in FIGS. 3-13, a nozzle 2 is shaped to fit in the carrier 1 at the level of a hole 11. As more particularly seen in FIGS. 3 and 4, a nozzle 2 comprises a sleeve 3 suitable for being engaged in a hole 11. For this, the end of the sleeve 3 has a cross-section of a shape inscribed in the shape of a hole 11.

The sleeve 3 comprises a flange 31 surrounding the sleeve 3 and suitable for covering the outer periphery of the hole 11. Outer refers herein to the external surface of the carrier 1. Thus, the nozzle 2, in position in the hole 11, seals the hole 11 and forces the propellant air to flow into the main conduit formed by the nozzle 2. The flange 31 further serves as a stop in that it limits the in-depth driving of the nozzle 2 into the carrier 1. The flange 31 advantageously has in the plane thereof, a shape suitable for moulding the outer surface of the carrier 1 at the level of the hole 11. These two surfaces are advantageously planar.

In order to fasten the nozzle 2 to the carrier 1, the nozzle 2 further comprises two tappets 32, 42 protruding radially from the sleeve 3. Thus, these tappets 32, 42 can hook the inner periphery of the hole 11. Inner refers herein to the internal surface of the carrier 1. The nozzle 2 is thus held in that it abuts against the outside of the hole 11 with the flange 31 and against the inside of the hole 11 with the tappets 32, 42. For even distribution, these at least two tappets 32, 42 are preferentially diametrically opposed, on either side of the sleeve 3.

At least one tappet may be elastically retractable: an elastic return means tends to place same in the hooked or extended position, a contact for example with the edge of the hole 11 carries out the retraction thereof, advantageously subject to sufficient force.

According to a further embodiment, more particularly illustrated in FIGS. 3 and 4, one of said at least two tappets 32 is fixed and another of said at least two tappets 42 is movable between a hooked position where it may hook the inner periphery of the hole 11 and a retracted position.

It is thus possible by engaging the nozzle 2 in the hole 11 on the side of the fixed tappet, herein the upper tappet 32, to slide the latter behind the wall of the hole 11. The movable tappet, herein the lower tappet 42 being retracted, as illustrated in FIG. 4, does not impede the completion of the positioning of the nozzle 2 by engaging the nozzle 2 in the hole 11 on the side of the movable tappet 42. Then, the movable tappet 42 is moved in the locked position, as illustrated in FIG. 3. In this position, the movable tappet 42 hooks the surface of the hole 11 from the inside and locks the nozzle 2 in the hole 11.

According to a feature of the invention, the change of position of the movable tappet 42 is enabled by a lever 4. This lever 4 is hinged in relation to the sleeve 3 by an axle 43 placed in a seat 34. The tappet 42 is integral with the lever 4 the rotation whereof enables the change of position. The lever 4 further comprises a control 41 disposed on the outside, in order to be capable of being operated readily. The outside denotes herein in relation to the carrier 1 when the nozzle 2 is in position in the hole 11. FIG. 3 shows the lever 4 in the open or released position, the tappet 42 being retracted essentially into the sleeve 3. FIG. 4 shows the lever 4 in the closed or locked position, the movable tappet 42 being extended so as to hook the inner wall of the carrier 1 between the tappet 42 and the flange 31.

According to a further feature, more particularly visible in FIGS. 7 and 8, an, advantageously double, protuberance 37 is disposed on the sleeve 3 in order to hold the lever 4 in the closed position. This protuberance 37 is advantageously conical. Thus the inclined portion favours retraction of the protuberance 37 and the change to the closed position, whereas the perpendicular portion then retains the lever 4. Movement of the lever 4 remains however possible in both directions due to the flexibility of the strip supporting the protuberance 37 and enabling the retraction thereof. This flexibility is enhanced by the close cut-out section 39. Greater force is required to leave the closed position.

According to a further important feature, more particularly seen in FIGS. 3 and 4, the sleeve 3 comprises a scoop 33 facing the propellant air supply, when the nozzle 2 is in position in the carrier 1, and a bend between the scoop 33 and the flange 31. A first function of the nozzle 2 is that of receiving propellant air from the carrier 1. For this, the nozzle 2 is connected to the carrier 1 and immerses the end of the sleeve 3, i.e. a scoop 33, directly into the propellant air stream in order to capture a portion of the propellant air circulating in the carrier 1. The direction of the carrier 1 is substantially vertical. As a result, the propellant air arrives from a substantially vertical direction, most frequently downward. The axis of diffusion of the nozzle 2 is substantially horizontal. In order to limit pressure drop upon the change of direction, the sleeve 3 has a bent shape between the scoop 33 and the flange 31. This bend makes it possible to orient the scoop 33 forming the inlet of the sleeve 3 facing the direction of supply and guide the propellant air by helping it to change direction gently.

In order to evenly distribute the propellant air flows, the sleeve 3 may comprise intermediate walls 35, advantageously also bent, preferentially parallel with the bend. For the same reason, the openings of the scoop 33 may have funnel shapes. The surface areas of the openings of the scoop 33 may be different, for example increasing from top to bottom in order to compensate for the path lengths increasing from top to bottom.

Advantageously, the presence of a scoop 33 and a bend makes it possible to carry out useful interpenetration of the nozzle 2 in the carrier 1. Thus, for the same horizontal propellant air path length, necessary for satisfactory steerability, the depth, along the axis of the nozzle 2, of the device comprising the carrier 1 and the nozzle 2 may be substantially reduced.

Equipped with the scoop 33 thereof, the nozzle 2 captures a portion of the propellant air circulating in the carrier 1. In order to prevent a nozzle 2 positioned upstream from overly disturbing the propellant air flow for the more downstream nozzles, or from extracting an excessive quantity of air, according to a further feature, the carrier 1 is shaped, as illustrated in FIG. 1, so as to have an increase 12 in cross-section at the level of a hole 11. Thus shaped to have a “bubble” around the nozzle 2 and the scoop 33 thereof, the carrier 1 favours satisfactory flow of the propellant air and ensures that a more downstream nozzle 2, including the last, receives a sufficient quantity of propellant air.

It has been seen that the sleeve 3 provides the interface between the carrier 1 and the inlet of propellant air into the nozzle 2. A further function of the nozzle 2 is diffusing the propellant air towards the target, typically a crop. For this, the nozzle 2 further comprises a housing 5. This housing 5 is disposed extending from the sleeve 3 and in fluidic continuity with the sleeve 3 in order to diffuse the air captured by the sleeve 3.

According to a further feature, the housing 5 is hinged in relation to the sleeve 3 by means of an axle 51, preferentially horizontal. This feature, more particularly illustrated in FIGS. 5 and 6, makes it possible to direct the air flow generally upwards or downwards. It is, according to an embodiment, obtained by means of a hinge axle 51 rigidly connected to the housing 5 and suitable for being engaged in a circular seat 34 formed in the sleeve 3. FIG. 5 illustrates a housing 5 oriented substantially perpendicularly to the sleeve 3, i.e. substantially horizontal when the flange 31 of the sleeve 3 is disposed vertically. Comparatively, FIG. 6 illustrates the same nozzle 2 with a housing 5 oriented upwards. The model represented in the figures thus enables an orientation of the housing 5 in relation to the sleeve 3 according to an angular amplitude for example of −30° to +30° C.

This feature is advantageously supplemented by an angular position locking means 44, 54, so that the setting withstands vibrations. Moreover, such a feature makes it possible to orient the housings of the nozzles manually in the desired manner according to the crops to be treated and according to any parameters such as the foliage of the crops.

According to an embodiment (not shown), the setting may be carried out continuously, with a locking means, such as a locking screw.

According to a further embodiment illustrated in the figures, the setting is performed according to several, herein three, discrete orientations: top, centre and bottom. The locking means may then be embodied by indentations 54 formed, for example, in the housing 5 and engaged by one or more locking finger(s) 44 rigidly connected to the sleeve 3.

Herein, according to a preferential embodiment, the finger 44 is rigidly connected to the lever 4 and is dual, i.e. it comprises two excrescences, each engaging in one of the notches 54 envisaged for this purpose, herein four in number. Thus, as more particularly seen in FIGS. 4 and 8, the lever 4 in the open position allows the rotation of the housing 5 in relation to the sleeve 3. On the other hand, the lever 4 in the closed position, engages the finger 44 in one of the notches 54 and locks the rotation of the housing 5 in relation to the sleeve 3. As a general rule, the numbers of excrescences and notches may vary, it being understood that the number of notches 54 is strictly greater than the number of excrescences, the number of the positions defining the discrete orientations varying according to the possible cooperation combinations between the excrescences of the locking finger 44 and the notches 54.

According to a further important feature, the housing 5 further comprises at least one hinged flap 6, 7, in relation to the housing 5. This at least one flap 6, 7 is shaped and disposed so as to vary the opening of the housing 5 and aperture angle of the sprayed jet.

This feature is advantageous in that a more open housing 5 makes it possible to spray at a shorter distance, for closer crops. On the other hand, a more closed housing 5 makes it possible to spray at a greater distance, for more distant crops.

Each flap 6, 7 is preferentially independently adjustable. The hinge axis 61, 71 of a flap is preferentially horizontal. As above, the setting may be continuous or according to discrete positions. A means for locking in position is advantageously used to enable the setting to withstand vibrations.

In the embodiment illustrated, the housing 5 comprises two flaps 6, 7, preferentially symmetrical, in relation to one another, disposed in the top part and in the bottom part of the housing 5.

The flap 6 is hinged about the axis 61 which is positioned in the seat 57. The locking means comprises a pair of symmetrical studs 62, on the flap 6 side, which are each engaged in a pair of corresponding grooves 55, on the housing 5 side. The groove 55 has a circular elongated shape in order to follow the stud 62. It has a narrow width, widening at the level of three positions having a circular widening and allowing three setting/locking positions of the flap 6. A stud 62 has three diameters, from the base to the head: a first diameter corresponding to the circular widening, a second smaller diameter corresponding to the narrow width of the groove 55 and a third diameter larger than the other two forming a head. The head prevents the stud 62 from coming out of the groove 55, in operation. The first diameter is that which is aligned, in depth, with the groove 55 when the flap 6 is at rest and makes it possible by being lodged in a circular widening to lock the movement of the stud 62 in one of the locking positions. The second diameter is that which is aligned, in depth, with the groove 55 when the flap 6 is deformed by pressing on the two studs 62 of a pair, thus enabling the studs 62 to move along the groove 55 thereof and the flap 6 with them. When the pressure on the studs 62 is released, the flap 6 returns to a resting position and can be locked when the first diameter encounters a locking position.

According to a further feature, the groove 55 further has a hole of greater diameter than the circular widenings, corresponding to the diameter of the head of the stud 62. This hole enables the head of the stud 62 to fit in the groove 55 when mounting/dismounting the flap 6 with the housing 5.

Similarly, the flap 7 is hinged about the axis 71 which is positioned in the seat 58. The locking means comprises a pair of symmetrical studs 72 on the flap 6 side, which are each engaged in a pair of corresponding grooves 56 on the housing 5 side.

Each of the flaps 6, 7 may thus, independently, be in an open, centre or closed position. FIG. 5 illustrates the flaps 6,7 both in the open position. FIG. 6 illustrates the upper flap 6 in the closed position and the lower flap 7 in the centre position.

The flaps 6, 7 make it possible to vary the size of the opening twofold from that with the two flaps closed to that with the two flaps open.

According to a further important feature, the nozzle 2 further comprises an adjustable sealing means 8. As described, the nozzle 2 generally forms an air duct. In order to evenly distribute the flow rates between different nozzles of a single carrier 1, it is advantageous to be able to partially or completely seal one or more nozzles 2. According to the configuration of the crops, higher or lower, it may be useful to block a nozzle 2. Also it is advantageous to be able to seal a nozzle 2 completely.

These setting possibilities offer versatility to the device 1, which can thus treat different crop configurations, low, high, etc., with the same device 1. According to the prior art, it is known to stop the phytosanitary product supply of an unused nozzle. However, this nozzle continues to diffuse air. Closing the air by sealing the nozzle 2, makes it possible to prevent a loss of pressure and retrieve this air for the other nozzles 2 or save energy by reducing the power of the turbine producing the propellant air.

For this, according to an embodiment, the sealing means comprises a rotary valve 8 disposed in the nozzle 2. The valve 8 may be disposed in the sleeve 3 or preferentially, as illustrated, in the housing 5. This valve 8 is preferentially cylindrical to fit and seal a rectangular section of the housing 5. The valve 8 may alternatively be spherical to fit and seal a circular section of the housing 5. The axis 81 of rotation of the valve 8 may be of any description. A preferential vertical arrangement makes it possible advantageously to have the setting/locking means 82 above, respectively below the nozzle 2.

As particularly seen in FIGS. 8-10, the valve 8 rotates about an axis 81 engaged in a seat formed in the housing 5. FIG. 9 shows it in the open/flowing orientation. FIG. 10 shows it in the closed/locking orientation. Herein the setting and holding in position are carried out continuously. A screw 82 along with a circular groove covering 45° enables locking by tightening. The screw 82 advantageously serves as the external control of the valve 8.

Several setting locking means have been seen: continuous, in discrete positions and by means of indexing, clipping, or tightening. It is obvious that all these locking and/or setting means are given by way of illustration and are interchangeable.

In the field of spraying, there are essentially two dispersion modes of the phytosanitary product by means of the propellant air supplied by the nozzle 2: a so-called “pneumatic” mode and a so-called “air-assisted spray” mode.

FIGS. 11 and 12 illustrate a nozzle 2 configured in pneumatic mode. In pneumatic mode, the phytosanitary product is mixed with the propellant air by means of a member known as a discharger 9. Such a discharger 9 comprises a phytosanitary product outlet and one or two dispersion wings. The discharger 9 must preferentially be disposed in the propellant air flow at the outlet of the nozzle 2.

For this, according to a feature, a nozzle 2 comprises a fastening means 52, in the form of a notch formed in the opening of the housing 5, suitable for enabling the mounting, typically by clipping, of a discharger 9. In order to connect a discharger 9 to the phytosanitary product distribution network 13, a distribution block 92 should be inserted. This distribution block 92 is connected to the phytosanitary product distribution network 13 by a conduit (not shown) and connected to the discharger 9 by a hose 91. The nozzle advantageously comprises on one or two of the faces thereof a mounting interface 53, for example of the quarter-turn locking type. This mounting interface 53 is advantageously used to mount the distribution block 92 directly on the nozzle 2 as close as possible to the discharger 9.

FIG. 13 illustrates a nozzle 2 configured in air-assisted spray mode. In air-assisted spray mode, the phytosanitary product is sprayed directly, under pressure, by a sprinkler 10. The mist produced is then blown by the propellant air towards the target. The sprinkler 10 is preferentially disposed offset laterally in relation to the propellant air flow from the nozzle 2.

For this, according to a feature, a nozzle 2 comprises a fastening means 53, of a sprinkler 10 or of a support block 93 which provides support for the sprinkler 10 and the connection to the phytosanitary product distribution network 13. The nozzle advantageously comprises on one or two of the faces thereof such a fastening means 53, for example of the quarter-turn locking type. This fastening means 53 is advantageously the same as that used for mounting the distribution block 92 of the discharger 9. The support block 93/sprinkler 10 is mounted to the left or right of the nozzle 2, according to the direction of movement of the nozzle 2 in relation to the crops.

Thus the nozzle 2 according to the invention has great versatility in that it is compatible with both spraying modes: pneumatic or and air-assisted.

The nozzle 2 is advantageously made of plastic material. It may be obtained by moulding or by additive technology.

The nozzle 2 may further, according to needs, be embodied in several sizes.

According to an advantageous feature, all the parts of the nozzle 2, more particularly visible in the exploded view in FIG. 8, are like the nozzle 2 itself, designed to be manually mountable and dismountable, using the elasticity of the plastic material, if applicable in addition to cut-out sections. The mounting/dismounting is performed advantageously without tools.

According to a further advantageous feature, as illustrated in the figures, the nozzle 2 is designed such that all the parts thereof are fool-proofed so as only to be suitable for being mounted in a single manner.

According to a further feature, the small parts, particularly the screws are captive, thanks to a clip-fastening ring disposed on the rod extended beyond the thread.

According to a further feature, the various screws, screw 81 of the valve 8 and the screws of the distribution block 92 and the support block 93 are identical so as to reduce the number of spare parts.

According to an advantageous configuration, the support block 93 whether it consists of the support of the sprinkler 10 or the support interfacing the distribution block 92 with the discharger 9 (as illustrated in FIG. 11 for example) enabling the connection to the phytosanitary product distribution network 13, comprises a closing screw 94, this screw 94 enabling the closure, particularly manual, of the supply of liquid to be sprayed.

As illustrated with reference to FIGS. 14, 15 and 15B, this closing screw 94 is reversible between two positions: this screw particularly comprises a central wheel from which extends:
on a first side, a first relatively short threaded rod enabling the screwing thereof to the support block 93, and
on another side, opposite the first side, a second threaded rod extended by a head forming a relatively long rod, enabling on one hand the screwing to the support block 93 and the closure of the supply of liquid to be sprayed in the support block 93.

In this way, when the first rod is visible and protruding outwards, the second rod is screwed into the support block (see FIG. 15A) configured to press against an anti-drip device and suitable for closing the spray and conversely, when the second rod is visible and protruding outwards, the first rod is screwed into the support block (see FIG. 15A) suitable for opening the spray, while leaving the screw 94 fastened to the nozzle 2.

According to an advantageous embodiment, at least one among the movable elements including the housing 5, the flap 6, the flap 7, sealing means 8, is controlled by an actuator. Such an actuator may be of any type, such as electrical or pneumatic.

This enables remote and/or automatic control. Such a control is typically interfaced by a processing unit, of the processor type.

Remote control may enable an operator, typically from the cab of the agricultural machine, or other, to configure the nozzle(s) 2 according to the configuration of the crops known or observed by the operator, if applicable while driving during spraying. The operator/processing unit interface may be integrated such as a keyboard or a mouse, or indeed by means of a connected device such as a telephone or a tablet. Thus, in the case of dense vegetation, the operator may prefer in-depth penetration of the phytosanitary products and therefore set the flaps 6, 7 to the closed position so as to have a reduced opening of the nozzle 2.

Automatic control may make it possible to configure the nozzle(s) according to a configuration stored in memory or indeed according to an automatic observation of the environment and/or the crops. Thus, the sensors observing the plants may be suitable for modifying the configuration of the nozzles accordingly, according to the observation results. The sensors may be of any type, including an image processing system.

Thus, according to the presence/absence of vegetation with regards to a nozzle, opening/closure of the valve may be actuated. According to a measured distance to the crops, the opening of the flaps 6, 7 may be modified, in order to favour the homogeneity of the dispersion of the phytosanitary product.

1-14. (canceled)

15. Spraying device for agricultural machine, comprising a carrier (1) and at least one nozzle (2) suitable for spraying an aerosol product, the carrier (1) being hollow so as to be suitable for transporting a propellant air to said at least one nozzle (2), wherein said at least one nozzle (2) is selectively mountable and dismountable in respect of the carrier (1), preferentially without tools.

16. Device according to claim 15, where the carrier (1) comprises at least one hole (11) cut out in the wall thereof and a nozzle (2) comprises a sleeve (3) suitable for being engaged in a hole (11), a flange (31) surrounding the sleeve (3) and suitable for covering the outer periphery of the hole (11), and at least two tappets (32,42) protruding radially from the sleeve (3) so as to be able to hook/engage the inner periphery of the hole (11), preferentially opposite in relation to the hole (11).

17. Device according to claim 15, where the nozzle forms an assembly configured to mix a phytosanitary product with the propellant air to form an aerosol, this assembly being removable in one piece in relation to the carrier (11).

18. Device according to claim 15, where one of said tappets (32) is fixed and the other of said at least two tappets (42) is movable between a hooked position where it can hook the inner periphery of the hole (11) and a retracted position, the change of position being capable of being made by means of a lever (4) comprising a control (41) preferentially disposed on the outside.

19. Device according claim 15, where the sleeve (3) comprises a scoop (33) facing the propellant air supply and forms a bend between the scoop (33) and the flange (31).

20. Device according to claim 15, where the carrier (1) comprises an increase (12) in cross-section around a hole (11).

21. Device according to claim 15, where the nozzle (2) further comprises a housing (5), disposed extending from the sleeve (3) and hinged in relation to the sleeve (3), preferentially along a horizontal axis (51).

22. Device according to claim 15, where the housing (5) further comprises at least one hinged flap (6, 7) so as to vary the opening of the housing (5), each flap (6, 7) being preferentially independently adjustable, and the hinge axis (61, 71) thereof being further preferentially horizontal.

23. Device according to claim 22, where the housing (5) comprises two flaps (6, 7), preferentially symmetrical.

24. Device according to 15, where the nozzle (2) further comprises an adjustable sealing means (8).

25. Device according to claim 24, where the sealing means comprises a rotary valve (8) disposed in the housing (5), preferentially cylindrical and more preferentially of vertical axis (81).

26. Device according to claim 15, where the nozzle (2) further comprises a fastening means (52) of a discharger (9) in the opening of the housing (5) and/or a fastening means (53) of a sprinkler (10) next to the opening of the housing (5).

27. Nozzle (2) suitable for spraying an aerosol product for a spraying device for agricultural machine of the type comprising a hollow carrier (1) so as to be suitable for transporting a propellant air to said nozzle (2) and the carrier (1) comprising at least one hole (11) cut out in the wall thereof, the nozzle (2) being configured to be selectively mountable and dismountable in respect of the carrier (1), preferentially without tools, and in that it comprises a sleeve (3) suitable for being engaged in the hole (11), a flange (31) surrounding the sleeve (3) and suitable for covering the outer periphery of the hole (11), and at least two tappets (32,42) protruding radially from the sleeve (3) so as to be able to hook/engage the inner periphery of the hole (11), preferentially opposite in relation to the hole (11).

28. Nozzle (2) according to claim 27, where it forms an assembly configured to mix a phytosanitary product with the propellant air to form an aerosol, this assembly being removable in one piece in relation to the carrier (11).
